(19) United States
(12) Patent Application Publication
(10) Pub. No.: US 2026/0338170 A1
(43) Pub. Date: Oct. 29, 2026

(54) HIGH-FREQUENCY INDUCTION HEATED JET ENGINE

(71) Applicant: Gorbette Holdings, LLC, Springtown, TX (US)

(72) Inventor: Travis Gorby, Sanger, TX (US)

(21) Appl. No.: 19/662,280

(22) Filed: Apr. 29, 2026

Related U.S. Application Data
(60) Provisional application No. 63/796,462, filed on Apr. 29, 2025.

(51) Int. Cl. F03H 99/00; H05B 6/10

(52) U.S. Cl. CPC F03H 99/00; H05B 6/108; F05D 2210/12; F05D 2250/232; F05D 2300/13; F05D 2300/224

(57) ABSTRACT

A high-frequency induction heated propulsion system generates thrust by directing a working medium along a flow path, inductively heating an electrically conductive susceptor disposed within the flow path with a high-frequency electromagnetic field generated by an induction coil, transferring heat from the susceptor to the working medium by convection, and expanding and expelling the heated working medium through an expansion region. The working medium is heated without combustion of fuel within the flow path. In a preferred jet engine embodiment, the susceptor comprises a heat exchange cylinder having a graphite core, a tungsten outer layer, tungsten internal fins, and a frustoconical profile that limits back-pressure. A liquid injector may introduce water or alcohol that flashes to gas at the susceptor to augment thrust. A coil cooling jacket maintains the induction coil below a thermal limit during operation.

### CROSS-REFERENCE TO RELATED APPLICATION

This application claims the benefit of U.S. Provisional Patent Application No. 63/796,462, filed Apr. 29, 2025, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to induction-heated propulsion systems, and more specifically, to a high-frequency induction heated propulsion system for generating thrust through controlled expansion of a working medium heated by inductive coupling without combustion of fuel within a thrust chamber.

### 2. Description of Related Art

This background information is intended to further educate the reader as to additional aspects of the prior art and may present examples of specific aspects of the prior art that is not to be construed as limiting the disclosure of the present application.

Conventional jet engines generate thrust by drawing in ambient air through a compressor stage, mixing the compressed air with a fuel within a combustion chamber, and igniting the mixture to produce a high-temperature exhaust stream that expands through a nozzle. Operating temperatures within such combustion chambers typically range from approximately 2,100°F to 2,300°F. The continuous combustion process consumes substantial quantities of fuel during operation and is constrained by the thermodynamic limits of chemical-energy conversion.

Electrothermal propulsion systems have been proposed as alternatives to combustion-based engines. Such systems heat a flowing propellant by electrical means rather than by burning the propellant. Resistive electrothermal thrusters direct a propellant over an electrically heated resistor, while arcjet thrusters establish an electric arc within a propellant stream. These approaches require electrodes in direct contact with the propellant or with a heating element, which complicates thermal management, limits service life, and constrains the choice of working medium.

High-frequency induction heating is well established in industrial applications such as metallurgy, semiconductor processing, and chemical processing. Induction heating employs an induction coil energized by a high-frequency alternating current to generate a rapidly alternating electromagnetic field. The alternating electromagnetic field penetrates an electrically conductive object and induces eddy currents within the object. The eddy currents flow through the resistance of the object and dissipate as heat. In ferromagnetic materials, magnetic hysteresis losses contribute additional heating. The effectiveness of induction heating depends on object size, material properties, coupling between the induction coil and the heated object, and field penetration depth.

Notwithstanding the maturity of induction heating in industrial settings, the use of high-frequency induction heating to drive a flowing working medium for purposes of thrust generation has not been widely realized. Industrial induction reactors are typically configured as stationary, batch, or low-throughput systems and are not designed to manage the mass flux, transient temperature gradients, and back-pressure dynamics that arise when a continuously flowing working medium is heated to temperatures suitable for propulsion.

Refractory materials such as graphite and tungsten exhibit melting temperatures well above conventional jet-engine operating temperatures. Graphite has a sublimation or melting range of approximately 6,740 °F to approximately 8,540 °F, and tungsten has a melting point of approximately 6,191 °F. These materials enable thermal architectures that operate well in excess of the temperatures attainable by combustion in conventional jet engines.

Accordingly, there exists a need for a high-frequency induction heated propulsion system for generating thrust through controlled expansion of a working medium heated by inductive coupling without combustion of fuel within a thrust chamber.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The disclosure of the present application addresses the above stated deficiencies with conventional propulsion systems. The present disclosure provides a high-frequency induction heated propulsion system for generating thrust through controlled expansion of a working medium heated by inductive coupling without combustion of fuel within a thrust chamber.

In one aspect, an induction-heated propulsion system is provided. The system comprises a flow path configured to direct a working medium therethrough, an induction coil arranged to generate a high-frequency electromagnetic field, and a susceptor disposed within the flow path and positioned within the high-frequency electromagnetic field. The susceptor comprises an electrically conductive material configured to inductively couple energy from the high-frequency electromagnetic field via eddy currents to heat the susceptor. An expansion region is disposed downstream of the susceptor and is configured to expand and expel the working medium heated by transfer from the susceptor to produce thrust. A power source is coupled to the induction coil and is configured to drive the induction coil at a frequency selected to inductively heat the susceptor. The working medium is heated by transfer from the susceptor without combustion of fuel within the flow path.

In another aspect, a method of generating thrust includes directing a working medium along a flow path, generating a high-frequency electromagnetic field with an induction coil arranged about a susceptor disposed within the flow path, inductively coupling energy from the high-frequency electromagnetic field into the susceptor via eddy currents to heat the susceptor, transferring heat from the susceptor to the working medium by convection as the working medium flows along the susceptor, and expanding and expelling the heated working medium through an expansion region to produce thrust, the working medium being heated without combustion of fuel within the flow path.

In a further aspect, a jet engine includes an air intake, a compressor section configured to compress air received from the air intake along a flow path, and a heat exchange cylinder disposed within the flow path downstream of the compressor section. The heat exchange cylinder comprises a graphite core, a tungsten outer layer disposed on an exterior of the graphite core, and a plurality of tungsten internal fins extending into the flow path. The heat exchange cylinder has a frustoconical profile that tapers from an inlet end to an outlet end. A high-frequency induction coil is disposed externally of the heat exchange cylinder and is arranged to generate a high-frequency electromagnetic field that inductively heats the heat exchange cylinder via eddy currents. An exhaust nozzle is disposed downstream of the heat exchange cylinder and is configured to expel the air heated by the heat exchange cylinder to produce thrust, the air being heated by transfer from the heat exchange cylinder without combustion of fuel within the flow path.

In certain embodiments, the system further includes a liquid injector configured to introduce a liquid such as water, alcohol, or a mixture thereof into the flow path upstream of the expansion region. The liquid undergoes phase transition to a gas upon contact with or proximity to the heated susceptor to augment thrust through rapid volumetric expansion. In further embodiments, a coil cooling jacket is arranged adjacent the induction coil to flow a coolant such as water and to maintain the induction coil below a thermal limit during operation.

### BRIEF DESCRIPTION OF THE DRAWINGS

The accompanying drawings, which are incorporated in and constitute a part of this disclosure, illustrate exemplary aspects and, together with the description, serve to explain the disclosed principles. Some aspects of system and/or methods in accordance with aspects of the present subject matter are now described, by way of example only, and with reference to the accompanying Figures, in which:
FIG. 1 is a longitudinal cutaway view of a high-frequency induction heated propulsion system arranged as a jet engine in accordance with a preferred embodiment of the present application.
FIG. 2 is an enlarged cutaway view of the induction-heating section of FIG. 1 showing a heat exchange cylinder, induction coils, and internal fins in accordance with a preferred embodiment of the present application.
FIG. 3 is a schematic block diagram of a high-frequency induction heated propulsion system in accordance with an embodiment of the present application.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the present disclosure, reference will now be made to the embodiment illustrated in the drawings, and specific language will be used to describe the same. It will nevertheless be understood that no limitation of the scope of the disclosure is thereby intended. Such alterations and further modifications in the illustrated system, and such further applications of the principles of the disclosure as illustrated therein would be contemplated as would normally occur to one skilled in the art to which the disclosure relates. Unless otherwise defined, all technical and scientific terms used herein have the same meaning as commonly understood by one of ordinary skilled in the art. The system, methods, and examples provided herein are illustrative only and are not intended to be limiting.

Referring now to the drawings, and more particularly to FIGS. 1-3, there are shown preferred embodiments of an induction-heated propulsion system 100. The propulsion system 100 generates thrust by directing a flowing working medium 108 along a flow path 107, inductively heating a susceptor 101 disposed within the flow path 107 with one or more induction coils 103, transferring heat from the susceptor 101 to the working medium 108, and expanding and expelling the heated working medium 108 through an expansion region 109. Heating of the working medium 108 occurs without combustion of fuel within the flow path 107.

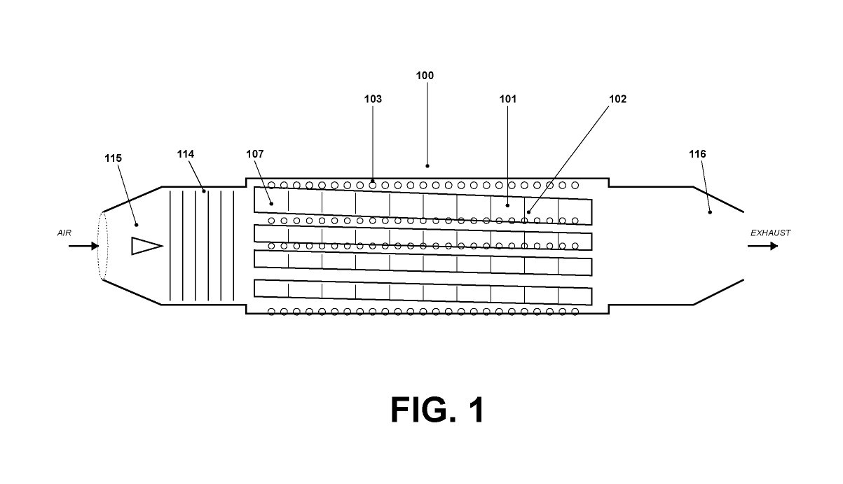

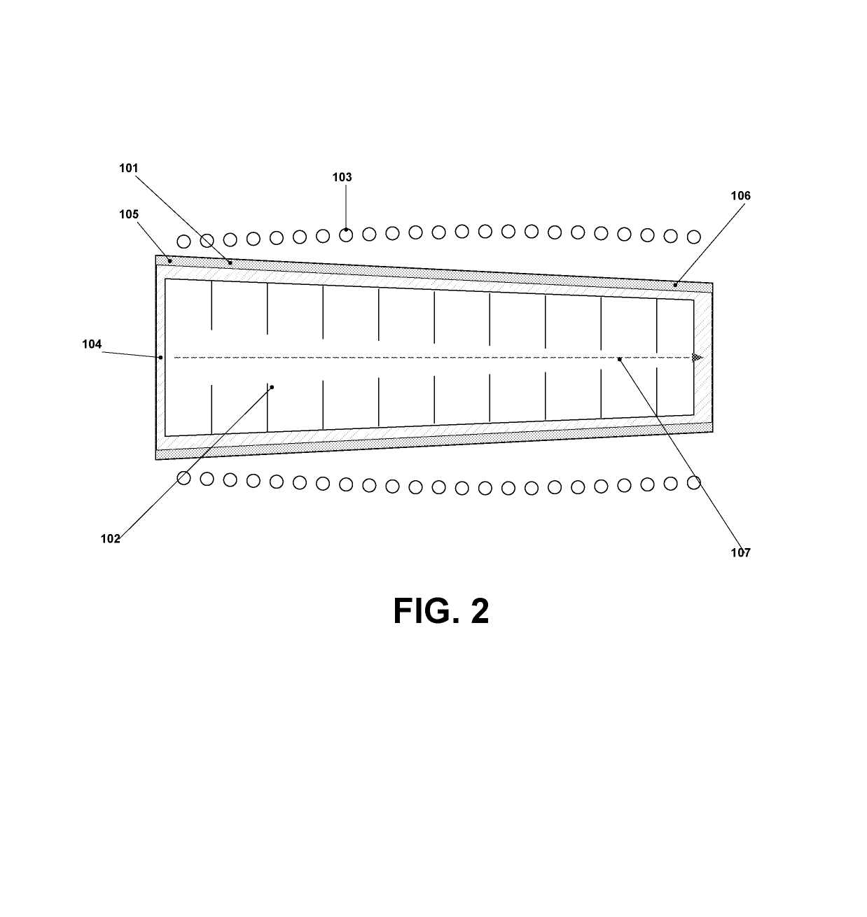

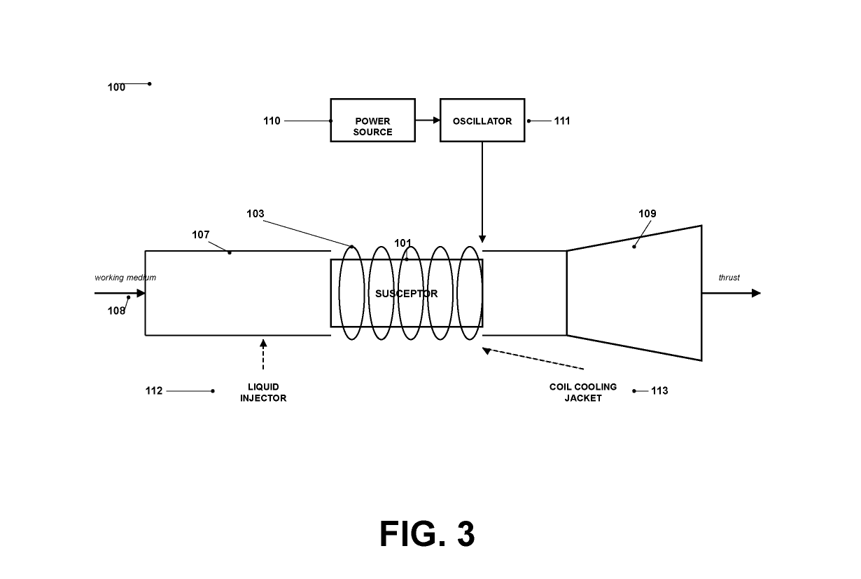

As shown schematically in FIG. 3, the propulsion system 100 includes the flow path 107 along which the working medium 108 travels in a generally downstream direction. The flow path 107 has an upstream inlet through which the working medium 108 enters and a downstream outlet from which the heated working medium 108 is expelled. The susceptor 101 is disposed within the flow path 107 between the upstream inlet and the downstream outlet such that the working medium 108 passes adjacent to or through the susceptor 101 during operation.

The induction coil 103 is arranged about, alongside, or in proximity to the susceptor 101 such that a high-frequency electromagnetic field generated by the induction coil 103 penetrates the susceptor 101. In one embodiment, the induction coil 103 is wound circumferentially about an exterior surface of the susceptor 101. In another embodiment, the induction coil 103 is arranged adjacent to the susceptor 101 within an enclosure surrounding the flow path 107. In a further embodiment, a plurality of induction coils 103 are distributed along the length of the flow path 107 to provide distributed heating.

The expansion region 109 is disposed downstream of the susceptor 101 and provides a flow geometry that expands the heated working medium 108 to produce thrust. In one embodiment, the expansion region 109 comprises a converging-diverging nozzle. In another embodiment, the expansion region 109 comprises a diverging exhaust nozzle. The expansion region 109 may be integrally formed with a downstream end of the susceptor 101 or may be a separate component disposed downstream of the susceptor 101.

The power source 110 supplies electrical energy to the induction coil 103. The power source 110 includes an oscillator 111 configured to generate a high-frequency alternating current that drives the induction coil 103. In one embodiment, the oscillator 111 operates at a frequency in a range of from 10 kHz to 10 MHz, and in a preferred embodiment in a range of from 100 kHz to 1 MHz. The selected frequency depends on the size of the susceptor 101, the electrical and magnetic properties of the susceptor 101, the desired field penetration depth, and the coupling efficiency between the induction coil 103 and the susceptor 101.

The susceptor 101 is a structure of electrically conductive material disposed within the flow path 107. The susceptor 101 inductively couples energy from the high-frequency electromagnetic field generated by the induction coil 103 via eddy currents and, where the susceptor 101 includes a ferromagnetic component, via magnetic hysteresis losses. The susceptor 101 transfers the resulting thermal energy to the working medium 108 primarily by convective heat transfer as the working medium 108 flows along surfaces of the susceptor 101.

In one embodiment, the susceptor 101 comprises a heat exchange cylinder having an interior surface defining at least a portion of the flow path 107 and an exterior surface positioned within the high-frequency electromagnetic field generated by the induction coil 103. In another embodiment, the susceptor 101 comprises a plurality of heat exchange cylinders arranged in parallel or in series along the flow path 107. In a further embodiment, the susceptor 101 comprises a porous or honeycomb structure with internal flow channels through which the working medium 108 passes.

In a preferred embodiment, the susceptor 101 includes a graphite core 104 and a tungsten outer layer 105 disposed on an exterior of the graphite core 104. The graphite core 104 provides high inductive coupling efficiency and high thermal conductivity, with a melting or sublimation range of approximately 6,740 °F to approximately 8,540 °F. The tungsten outer layer 105 has a melting point of approximately 6,191 °F and provides mechanical reinforcement for the relatively soft graphite core 104, surface protection against erosion by the flowing working medium 108, and resistance to oxidation at elevated operating temperatures.

The susceptor 101 may include a plurality of internal fins 102 extending into the flow path 107 to increase the surface area available for convective heat transfer. In a preferred embodiment, the internal fins 102 comprise tungsten and are arranged longitudinally along the interior surface of the heat exchange cylinder. In another embodiment, the internal fins 102 are arranged in a helical pattern about a central axis of the heat exchange cylinder to induce swirl in the working medium 108 and further enhance convective heat transfer.

In a preferred embodiment, the heat exchange cylinder has a frustoconical profile 106 that tapers from an inlet end to an outlet end. The frustoconical profile 106 provides a gradually expanding interior cross-section that accommodates volumetric expansion of the heated working medium 108 along the length of the heat exchange cylinder and limits buildup of back-pressure that might otherwise impede flow through the susceptor 101.

Materials suitable for the susceptor 101 are not limited to graphite and tungsten. In one embodiment, the susceptor 101 is constructed from a refractory material having a melting point in excess of 5,000 °F. In another embodiment, the susceptor 101 includes a ceramic component such as silicon carbide or zirconium carbide. In a further embodiment, the susceptor 101 is constructed from carbon steel for operation at lower temperatures, such as in a range of from approximately 2,597 °F to 2,800 °F. The preferred graphite core 104 and tungsten outer layer 105 combination provides optimal performance at the highest operating temperatures of the present disclosure, which in one embodiment exceed 5,000 °F.

The working medium 108 may comprise any flowable substance suitable for thermal expansion within the propulsion system 100. In one embodiment, the working medium 108 is ambient air drawn into the flow path 107 through an upstream compressor stage. In another embodiment, the working medium 108 is a stored gas such as nitrogen, hydrogen, or helium. In a further embodiment, the working medium 108 is a multi-phase mixture, such as ambient air mixed with an injected liquid that vaporizes during heating.

The propulsion system 100 may further include a liquid injector 112 configured to introduce a liquid into the flow path 107. In one embodiment, the liquid injector 112 introduces water into the flow path 107 upstream of, or within, the susceptor 101. In another embodiment, the liquid injector 112 introduces alcohol or a mixture of water and alcohol. The liquid undergoes a phase transition to a gas upon contact with or proximity to the heated susceptor 101. The rapid volumetric expansion associated with the phase transition augments thrust generated by the propulsion system 100. The flow rate of liquid introduced through the liquid injector 112 may be regulated based on a desired thrust output.

Operation of the propulsion system 100 at the elevated temperatures contemplated by the present disclosure may impose thermal stress on the induction coil 103. To maintain the induction coil 103 below a thermal limit, in one embodiment the system 100 includes a coil cooling jacket 113 arranged adjacent the induction coil 103. The coil cooling jacket 113 conveys a coolant in thermal communication with the induction coil 103. In one embodiment, the coolant comprises water. In another embodiment, the coolant comprises a high-temperature heat-transfer fluid selected for thermal stability at the operating temperatures of the propulsion system 100. The coil cooling jacket 113 may include a closed-loop circulation system with a heat exchanger that rejects heat extracted from the induction coil 103 to a cooler external sink.

The power source 110 supplies electrical energy to the induction coil 103 through the oscillator 111. In one embodiment, the power source 110 includes an electric generator powered by combustion of a fuel external to the flow path 107. In a further embodiment, the power source 110 includes a battery, a fuel cell, a photovoltaic array, or a connection to an external electrical grid. By powering the induction coil 103 with electrical energy supplied externally to the flow path 107, the propulsion system 100 produces thrust without combustion within the thrust path.

In one embodiment in which fuel is consumed by the electric generator, the rate of fuel consumption associated with operation of the propulsion system 100 is reduced relative to a conventional combustion-based jet engine of comparable thrust output. By way of example only, a 100 kW diesel-driven generator consumes approximately 7.5 gal/hr, which is substantially less than the rate at which fuel is consumed in the combustion chamber of a conventional jet engine. Specific consumption figures will depend on the size of the propulsion system 100 and the operating conditions and are not limiting.

Where a plurality of induction coils 103 are provided, each induction coil 103 may be independently controlled by the power source 110 to vary heating along the length of the flow path 107. Independent control of the induction coils 103 allows the temperature profile within the susceptor 101 to be tailored to the desired thrust output, the working medium 108 properties, and the operating conditions. Sensors monitoring susceptor temperature, working-medium temperature, mass-flow rate, or pressure may provide feedback signals to the power source 110 to support closed-loop control of the induction coils 103.

Referring now to FIGS. 1 and 2, in a preferred embodiment the propulsion system 100 is configured as a jet engine. The jet engine includes an air intake 115 disposed at an upstream end of the flow path 107, a compressor section 114 disposed downstream of the air intake 115, and an exhaust nozzle 116 disposed at a downstream end of the flow path 107. The compressor section 114 draws ambient air through the air intake 115 and compresses the air along the flow path 107. The compressed air flows from the compressor section 114 to the susceptor 101.

As shown in FIGS. 1 and 2, the susceptor 101 in the jet engine embodiment comprises one or more heat exchange cylinders disposed within the flow path 107 downstream of the compressor section 114. Each heat exchange cylinder includes the graphite core 104, the tungsten outer layer 105, and the plurality of tungsten internal fins 102 extending into the flow path 107. Each heat exchange cylinder has the frustoconical profile 106 that tapers from an inlet end adjacent the compressor section 114 to an outlet end adjacent the exhaust nozzle 116.

The high-frequency induction coil 103 is disposed externally of each heat exchange cylinder and is arranged to generate the high-frequency electromagnetic field that inductively heats the heat exchange cylinder via eddy currents. In one embodiment, a plurality of high-frequency induction coils 103 are arranged along the length of each heat exchange cylinder. In another embodiment, a high-frequency induction coil 103 is wound circumferentially about each heat exchange cylinder. The compressed air drawn from the compressor section 114 flows through and along the heated heat exchange cylinder and absorbs heat by convection from the interior surface and the internal fins 102.

The exhaust nozzle 116 receives the heated air from the heat exchange cylinder and expels the heated air at high velocity to produce thrust. The exhaust nozzle 116 may comprise a converging nozzle, a diverging nozzle, or a converging-diverging nozzle. In one embodiment, the exhaust nozzle 116 includes a variable-geometry mechanism configured to adjust the cross-sectional area of the nozzle based on operating conditions.

The length of each heat exchange cylinder, the number of heat exchange cylinders provided in parallel along the flow path 107, and the spacing of the high-frequency induction coils 103 along each heat exchange cylinder may be selected based on a desired pressure rise, a desired thrust output, and a desired mass-flow rate. By way of example, in one embodiment the heat exchange cylinders have a length in a range of from approximately one foot to approximately ten feet, and the high-frequency induction coils 103 are spaced along each heat exchange cylinder at intervals selected to provide a substantially uniform temperature distribution along the length of the susceptor 101.

In operation, the working medium 108 enters the upstream end of the flow path 107. In the jet engine embodiment, ambient air enters the air intake 115 and is compressed by the compressor section 114. The power source 110 supplies high-frequency alternating current to the one or more induction coils 103 through the oscillator 111. The high-frequency alternating current generates the high-frequency electromagnetic field that penetrates the susceptor 101 and induces eddy currents within the electrically conductive material of the susceptor 101. The eddy currents flow through the resistance of the susceptor 101 and dissipate as Joule heating. Where the susceptor 101 includes a ferromagnetic component, magnetic hysteresis losses contribute additional heating.

As the working medium 108 flows along the heated susceptor 101 heat transfers from the surface of the susceptor 101 and the internal fins 102 to the working medium 108 by convection. The working medium 108 thereby reaches an elevated temperature, which in one embodiment exceeds 5,000 °F. The heated working medium 108 expands volumetrically. The expanding working medium 108 flows into and through the expansion region 109 and is expelled from the downstream end of the flow path 107 to produce thrust. Where the propulsion system 100 is configured as a jet engine, the expanding working medium 108 is expelled through the exhaust nozzle 116.

Where the liquid injector 112 is provided, the liquid injector 112 introduces the liquid into the flow path 107 upstream of, or within, the susceptor 101. The liquid undergoes phase transition to a gas upon contact with or proximity to the heated susceptor 101. The volumetric expansion associated with the phase transition adds mass and energy to the working medium 108 and increases the thrust produced by the propulsion system 100.

It should be appreciated that the susceptor 101 is designed to operate at elevated temperatures and that the susceptor 101 will continue to function at lower temperatures consistent with the materials selected. Likewise, the depicted internal fins 102 serve as illustrative embodiments, and alternative embodiments capable of achieving heat exchange between the susceptor 101 and the working medium 108 are also feasible, including without limitation longitudinal fins, helical fins, pin fins, porous matrices, and honeycomb structures.

It should further be appreciated that, although the propulsion system 100 is described principally in connection with a jet engine embodiment, the propulsion system 100 may be configured as a rocket-style thruster operating on a stored working medium 108 in vacuum or near-vacuum conditions, as a propulsion unit for a marine vessel, as a propulsion unit for a terrestrial vehicle, or as a stationary thrust source. The principles of inductive heating of the susceptor 101 to expand the working medium 108 without combustion within the flow path 107 apply across these embodiments.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. An induction-heated propulsion system, comprising:
a flow path configured to direct a working medium therethrough;
an induction coil arranged to generate a high-frequency electromagnetic field;
a susceptor disposed within the flow path and positioned within the high-frequency electromagnetic field, the susceptor comprising an electrically conductive material configured to inductively couple energy from the high-frequency electromagnetic field via eddy currents to heat the susceptor;
an expansion region disposed downstream of the susceptor and configured to expand and expel the working medium heated by transfer from the susceptor to produce thrust; and
a power source coupled to the induction coil and configured to drive the induction coil at a frequency selected to inductively heat the susceptor,
wherein the working medium is heated by transfer from the susceptor without combustion of fuel within the flow path.

2. The induction-heated propulsion system of claim 1, wherein the susceptor comprises a heat exchange cylinder having an interior surface defining at least a portion of the flow path.

3. The induction-heated propulsion system of claim 2, wherein the heat exchange cylinder comprises a graphite core and a tungsten outer layer disposed on an exterior of the graphite core.

4. Theinduction-heated propulsion system of claim 2, wherein the heat exchange cylinder includes a plurality of internal fins extending into the flow path, the internal fins comprising tungsten.

5. The induction-heated propulsion system of claim 2, wherein the heat exchange cylinder has a frustoconical profile that tapers from an inlet end of the heat exchange cylinder to an outlet end of the heat exchange cylinder.

6. The induction-heated propulsion system of claim 1, further comprising a compressor stage disposed upstream of the susceptor and configured to compress ambient air into the flow path as at least a portion of the working medium.

7. The induction-heated propulsion system of claim 1, further comprising a liquid injector configured to introduce at least one of water and alcohol into the flow path upstream of the expansion region.

8. The induction-heated propulsion system of claim 1, wherein the susceptor is configured to operate at a temperature in excess of 5,000 °F.

9. The induction-heated propulsion system of claim 1, wherein the power source comprises an electric generator and an oscillator, the electric generator configured to be powered by combustion of a fuel external to the flow path, and the oscillator configured to drive the induction coil at a frequency in a range of from 10 kHz to 10 MHz.

10. The induction-heated propulsion system of claim 1, wherein the induction coil is one of a plurality of induction coils distributed along the flow path, each of the plurality of induction coils being independently controllable by the power source to vary heating along the flow path.

11. The induction-heated propulsion system of claim 1, further comprising a coil cooling jacket arranged adjacent the induction coil and configured to convey a coolant in thermal communication with the induction coil to maintain the induction coil below a thermal limit.

12. The induction-heated propulsion system of claim 1, wherein the susceptor comprises a refractory material having a melting point in excess of five thousand degrees Fahrenheit.

13. A method of generating thrust, comprising:
directing a working medium along a flow path;
generating a high-frequency electromagnetic field with an induction coil arranged about a susceptor disposed within the flow path;
inductively coupling energy from the high-frequency electromagnetic field into the susceptor via eddy currents to heat the susceptor;
transferring heat from the susceptor to the working medium by convection as the working medium flows along the susceptor; and
expanding and expelling the heated working medium through an expansion region downstream of the susceptor to produce thrust,
wherein the working medium is heated without combustion of fuel within the flow path.

14. The method of claim 13, wherein directing the working medium along the flow path comprises drawing ambient air through a compressor stage upstream of the susceptor.

15. The method of claim 13, further comprising injecting at least one of water and alcohol into the flow path, the at least one of water and alcohol vaporizing in contact with or proximate the susceptor to augment thrust produced through the expansion region.

16. The method of claim 13, wherein heating the susceptor comprises heating the susceptor to a temperature in excess of 5,000 °F.

17. The method of claim 13, further comprising flowing a coolant adjacent the induction coil to maintain the induction coil below a thermal limit.

18. A jet engine, comprising:
an air intake;
a compressor section configured to compress air received from the air intake along a flow path;
a heat exchange cylinder disposed within the flow path downstream of the compressor section, the heat exchange cylinder comprising a graphite core, a tungsten outer layer disposed on an exterior of the graphite core, and a plurality of tungsten internal fins extending into the flow path, the heat exchange cylinder having a frustoconical profile that tapers from an inlet end of the heat exchange cylinder to an outlet end of the heat exchange cylinder;
a high-frequency induction coil disposed externally of the heat exchange cylinder and arranged to generate a high-frequency electromagnetic field that inductively heats the heat exchange cylinder via eddy currents; and
an exhaust nozzle disposed downstream of the heat exchange cylinder and configured to expel the air heated by the heat exchange cylinder to produce thrust,
wherein the air is heated by transfer from the heat exchange cylinder without combustion of fuel within the flow path.

19. The jet engine of claim 18, further comprising a power source coupled to the high-frequency induction coil, the power source comprising an electric generator configured to be powered by combustion of a fuel external to the flow path.

20. The jet engine of claim 18, further comprising a liquid injector configured to introduce at least one of water and alcohol into the flow path upstream of the exhaust nozzle.
